(19) United States
(12) Patent Application Publication
(10) Pub. No.: US 2004/0210517 A1
(43) Pub. Date: Oct. 21, 2004

(54) Method and apparatus to transfer funds online

(75) Inventors: Chris Brooks, Sherwood, OR (US); David Brebner, Beaverton, OR (US)

Correspondence Address: Justin M . Dillon, Campbell Stephenson &Ascolese LLP, 4807 Spicewood Springs, Building 4 , Suite 201, Austin, TX, 78759, US

(73) Assignee: Corillian Corporation

(21) Appl. No.: 10/419,430

(22) Filed: Apr. 21, 2003

(51) Int. Cl. G06F 17/60

(52) U.S. Cl. 705/39

(57) ABSTRACT

A method and apparatus for transferring funds online from a customer's account at a first financial institution to a beneficiary's financial institution comprises receiving transaction information comprising a beneficiary's identity, an amount to transfer to the beneficiary's account, and the beneficiary's financial institution's identity. Sending a request to the beneficiary's financial institution, said request comprising the beneficiary's identity and the amount to transfer to the beneficiary's account, and debiting the customer's account at least the amount to transfer to the beneficiary's account if the beneficiary is a customer of the beneficiary's financial institution.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

1. Field of the Invention

The invention is related to the field of e-business. In particular, the invention is related to a method and apparatus to transfer funds online.

2. Description of the Related Art

Online banking services are commonplace. Many financial institutions or Internet portals permit a customer to review the customer's bank account status online, and to transfer funds from one account to another within the same financial institution or to a different financial institution. To transfer funds, a customer of a financial institution logs on to the financial institution's web-site and identifies a source account (i.e., an account from which funds are debited) and a destination account (i.e., a beneficiary's account to which funds area credited).

However, prior to transferring funds the customer of the financial institution first authenticates at the financial institution's web-site. Authenticating at a financial institution's web-site is well known and may include the customer providing e.g., a username and password etc. The customer then provides transaction information that includes the identity of the source and the beneficiary's accounts, and the amount of funds to transfer from the source account to the beneficiary's account. For example, the customer identifies the source account at the financial institution by e.g., providing an account number for the customer's account (i.e., an account from which the customer is authorized to withdraw funds). Thereafter, the customer identifies the beneficiary's account. Identification of the beneficiary's account includes e.g., the customer providing information that identifies the financial institution at which the beneficiary has an account, the name or identity of the beneficiary, and/or the account number of the beneficiary. The customer also identifies the amount of funds that are to be transferred from the source account to the beneficiary's account.

To transfer funds, the financial institution may debit the source account and may credit the beneficiary's account the amount identified by the customer if both the customer and the beneficiary have accounts at the same financial institution. However, if the customer has an account at a first financial institution and the beneficiary has an account at a second financial institution, the first financial institution may send the transaction information to a third party e.g., a clearing house for processing.

FIG. 1 illustrates a block diagram of conventional funds transfer architecture using a clearing house. As illustrated in FIG. 1 for customer 105 to transfer funds to beneficiary 125, the customer 105 authenticates at the customer's financial institution 110. Customer 105 may authenticate at the financial institution's web site either directly with the financial institution's web site, or indirectly via an Internet portal. After authenticating, the customer enters the transaction information. The customer's financial institution 110 sends the transaction information to clearing house 1115. The clearing house 115 may charge the first financial institution 110 (i.e., the customer's financial institution) and/or the second financial institution 120 (i.e., the beneficiary's financial institution) a processing fee to transfer the funds from customer 105 to beneficiary 125.

Sending transaction information to a clearing house for processing is inefficient and costly. Because, not only is the time taken to transfer funds increased, but also, the clearing house levies a charge for processing the transaction.

### BRIEF SUMMARY OF THE DRAWINGS

Example embodiments of the invention are illustrated in the accompanying drawings. The accompanying drawings, however, do not limit the scope of the invention. Similar references in the drawings indicate similar elements.

FIG. 1 illustrates a block diagram of conventional funds transfer architecture using a clearing house.

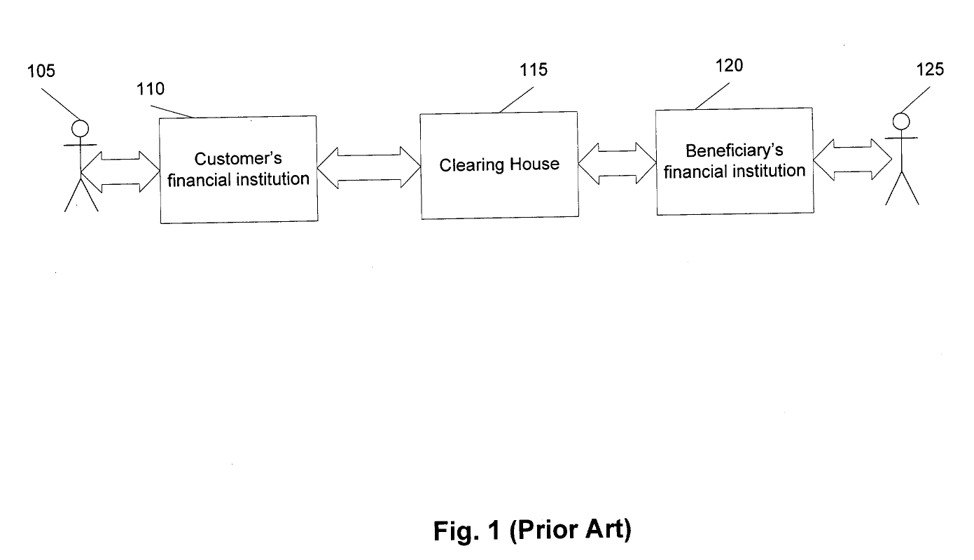

FIG. 2 illustrates a flow diagram for transferring funds online according to one embodiment of the invention.

FIG. 3 illustrates a flow diagram for transferring funds online according to another embodiment of the invention.

FIG. 4 illustrates a funds transfer module according to one embodiment of the invention.

FIG. 5 illustrates an apparatus for transferring funds online according to one embodiment of the invention.

### DETAILED DESCRIPTION

Described is a method and apparatus for transferring funds online. The method for transferring funds online from a customer's account at a first financial institution to a beneficiary's financial institution comprises receiving transaction information comprising a beneficiary's identity, an amount to transfer to the beneficiary's account, and the beneficiary's financial institution's identity. Sending a request to the beneficiary's financial institution, said request comprising the beneficiary's identity and the amount to transfer to the beneficiary's account, and debiting the customer's account at least the amount to transfer to the beneficiary's account if the beneficiary is a customer of the beneficiary's financial institution.

In another embodiment of the invention, the method for transferring funds online, between a first financial institution and a beneficiary's financial institution, comprises the first financial institution sending a first customer list to the beneficiary's financial institution and receiving a second customer list from the beneficiary's financial institution. The first and second customer list comprising customers of the corresponding financial institutions. The first financial institution receiving transaction information comprising a beneficiary's identity, an amount to transfer to the beneficiary's account, and the beneficiary's financial institution's identity. The first financial institution searches the first and the second customer lists to determine if the beneficiary's identity is on at least one of the first customer list and the second customer list. And, debits the customer's account at least the amount to transfer to the beneficiary's account if the beneficiary's identity is on at least one of the first customer list and the second customer list.

For the embodiments described above, if the beneficiary's identity is the first financial institution, or if the beneficiary is a customer of the first financial institution, the beneficiary's account at the first financial institution is credited. If the beneficiary's identity is on the second customer list, the first financial institution requests an authorization from the beneficiary's financial institution to transfer funds to the beneficiary's financial institution. On receiving the authorization from the beneficiary's financial institution, the first financial institution debits its customer's account and credits the beneficiary's financial institution's account.

Alternately, the first financial institution may send the funds to the beneficiary's financial institution and credit the account of the beneficiary's financial institution without seeking an authorization from the beneficiary's financial institution. The beneficiary's financial institution then credits the account of the beneficiary and may provide the beneficiary with e.g., notice of the deposit. The beneficiary's financial institution credits customers of the first financial institution via the methods illustrated above. In one embodiment of the invention, the first financial institution or the beneficiary's financial institution settles the net debt owed to the other via a periodic transfer of funds.

In one embodiment of the invention, a financial institution or an application service provider (ASP) may receive (e.g., via a network) the names or identities of the financial institutions that are in participate in transferring funds for their customers between the financial institutions. The financial institution or the ASP generates a list of the participating financial institutions. The identity of the financial institutions may include the financial institutions routing and transfer number (RTN), the financial institutions address etc. In one embodiment of the invention, the financial institution or the ASP may receive the customer lists from a plurality of financial institutions. The financial institution or the ASP may compile a master customer list that includes the name or identity of the customers, the corresponding account numbers of the customers, and the identity of the corresponding financial institutions. Alternately, the financial institution or the ASP may compile a list of participating financial institutions that includes the identity (name, address, RTN, etc.) of the financial institutions that are participating in transferring funds for their customers. The financial institution or the ASP compiling the master customer list or the list of participating financial institutions sends the list via a network e.g., the Internet to the plurality of participating financial institutions.

In the following description numerous specific details are set forth in order to provide a thorough understanding of the present invention. It will be apparent, however, to one of ordinary skill in the art that the present invention may be practiced without these specific details. In other instances, well-known architectures, steps, and techniques have not been shown to avoid obscuring the present invention.

The invention may utilize a distributed computing environment. In a distributed computing environment, program modules may be physically located in different local and remote memory storage devices. For example, the program code for compiling the master customer list may be stored on one server, and the program code for the funds transfer program, may be stored on a different server. Execution of the program modules may occur locally in a stand-alone manner on the same server, or evaluation of the program modules may occur remotely in a client/server manner. Examples of such distributed computing environments include local area networks, enterprise-wide computer networks, and the global Internet. Lastly, repeated usage of the phrase “in one embodiment” does not necessarily refer to the same embodiment, although it may.

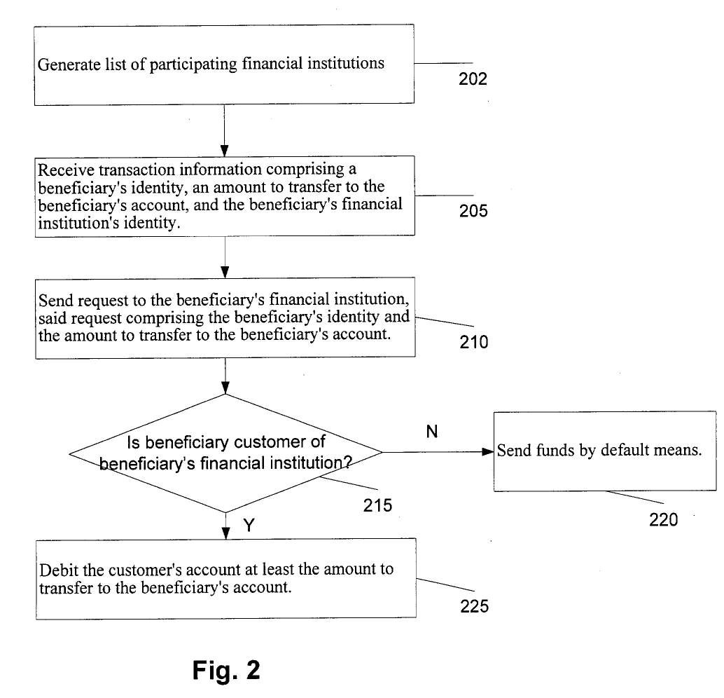

FIG. 2 illustrates a flow diagram for transferring funds online according to one embodiment of the invention. To transfer funds, at 202, a list of participating financial institutions is generated as illustrated above. Each financial institution may display the list of participating financial institutions on its web-site e.g., via a drop-down list. Thereafter, a customer of a financial institution authenticates at the customer's financial institution's web-site. Authenticating at a financial institution's web site may include e.g., the customer providing a username and password. The customer then provides transaction information, which includes the account number of the account from which funds are to be debited, terms regarding the transfer of funds, the identity of the beneficiary's financial institution (chosen e.g., from the drop-down list), and the identity of the beneficiary. In one embodiment of the information, when the customer provides transaction information, the customer may be provided with marketing information, e.g., banner advertisements for the financial institution's products. The identity of the beneficiary's financial institution may include the beneficiary's financial institution's name, address, or the financial institution's RTN, source code/sort code, etc. The identity of the beneficiary may include e.g., the beneficiary's account number, the beneficiary's name, the beneficiary's email address, etc.

The terms regarding the transfer of funds may include the amount of funds to transfer, whether the funds are transferred as a one-time occurrence or whether funds are to be periodically transferred. The time and date when the funds are to be transferred, whether the funds are transferred using a clearing house, etc.

As illustrated in FIG. 2, at 205 a financial institution wherein a customer has an account receives the transaction information e.g., from a customer or an agent of the customer. A financial institution may be defined as any institution that is financial in nature and includes an institution that at least provides financial services (e.g., checking and savings accounts) to the public.

At 210, the financial institution, and in particular a program executing on a machine at the customer's financial institution, sends a request to the beneficiary's financial institution. In one embodiment of the invention, the customer's financial institution and the beneficiary's financial institution are separate business entities and one may not be a subsidiary of the other. In one embodiment of the invention, the request may include the beneficiary's identity and the amount of funds to transfer to the beneficiary's account. In one embodiment of the invention, the customer's financial institution sends the request to the beneficiary's financial institution in real-time or at a time requested by the customer. In other embodiments of the invention the customer's financial institution sends the request to the beneficiary's financial institution in batch mode when there is e.g., a certain dollar amount of funds to be transferred to the beneficiary's financial institution. In still other embodiments of the invention the beneficiary's financial institution may periodically ping the customer's financial institution for the request, to see if there are any funds that are to be transferred from the customer's financial institution to the beneficiary's financial institution. When the beneficiary's financial institution pings the customer's financial institution to see if there are any funds that are to be transferred, the beneficiary's financial institution, and in particular a program executing on a machine at the beneficiary's financial institution, may first authenticate at the customer's financial institution. Thereafter, the beneficiary's financial institution may access a status page on the customer's financial institutions web site via a secure connection to check if a flag is set that indicates that there are funds to be transferred from the customer's financial institution to the beneficiary's financial institution.

On receiving a request from the customer's financial institution at 215, the beneficiary's financial institution determines if the beneficiary is a customer of the beneficiary's financial institution by e.g., searching a customer list. If the beneficiary is a customer of the beneficiary's financial institution, at 225, the beneficiary's financial institution sends an acknowledgement to the customer's financial institution and credits the account of the beneficiary the amount stated in the request. In one embodiment of the invention, on receiving the acknowledgement from the beneficiary's financial institution the customer's financial institution may debit the account of its customer at least the amount transferred to the beneficiary. In one embodiment of the invention, the customer's financial institution may charge the customer a service charge for transferring the funds to the beneficiary's account. Periodically, the customer's financial institution and the beneficiary's financial institution settle net payments with each other as a result of the various finds transfer transactions between the financial institutions. This means that if at the end of a certain period the customer's financial institution owes the beneficiary's financial institution a net amount, the customer's financial institution credits the account of the beneficiary's financial institution the net amount owed.

If at 215 it is determined that the beneficiary is not a customer of the beneficiary's financial institution at 220 the funds may be sent by the customer's financial institution to the beneficiary via default means. Default means may include printing the beneficiary a paper check and mailing it to the beneficiary, or by sending the transaction information to a clearing house for processing.

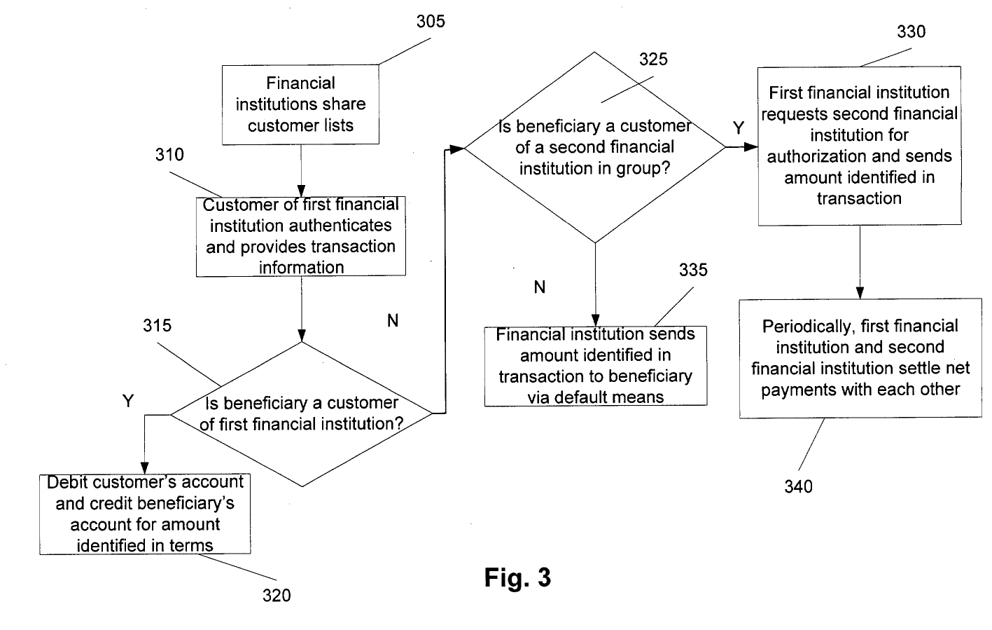

FIG. 3 illustrates a flow diagram for transferring funds online according to another embodiment of the invention. As illustrated in FIGS. 3, at 305 a plurality of financial institutions exchange their customer lists to form a master customer list. A customer list may be defined as a list comprising customer information including, the customer's name, address, the name of the financial institution at which the customer has an account, the customer's account number at the financial institution, etc.

In one embodiment of the invention, the exchange of customer lists between financial institutions may be done in a peer to peer manner. In a peer to peer exchange of customer lists, a first financial institution sends its customer list to a second financial institution and the second financial institution sends its customer list to the first financial institution. In one embodiment of the invention, the second financial institution may add its customer list to the customer list received from the first financial institution to form a master customer list and send the master customer list to the first financial institution. In one embodiment of the invention, the first financial institution and the second financial institution are separate business entities and one may not be a subsidiary of the other.

In one embodiment of the invention, the exchange of customer lists between a plurality of financial institutions may be done using a hub and spoke model. In the hub and spoke model, financial institutions comprising a plurality of financial institutions send their customer lists to a single financial institution or to an ASP. The single financial institution or the ASP combines the customer lists into the master customer list. The master customer list is then sent e.g., via a network to each of the plurality of financial institutions. The master customer list may be updated periodically e.g., daily, weekly, monthly, etc.

To transfer funds, at 310 a customer of a financial institution authenticates at the customer's financial institution's web-site and provides transaction information. Authenticating at a financial institution's web site and providing transaction information is as described with respect to FIG. 2 above.

At 315, the first financial institution, i.e., the financial institution receiving the transaction information, determines whether the beneficiary is also a customer of the first financial institution. The first financial institution may determine this by searching the master customer list. If the first financial institution determines that the beneficiary is also a customer of the first financial institution, at 320, the first financial institution debits the customer's account with at least the amount stated in the terms regarding the transfer of funds and credits the beneficiary's account with the amount transferred.

However, if at 315 the first financial institution determines that the beneficiary is not a customer of the first financial institution, at 325 the first financial institution determines whether the beneficiary is a customer of a second financial institution listed on the master customer list. If at 325, the first financial institution determines that the beneficiary is a customer of the second financial institution, at 330 the first financial institution may request an authorization, from the second financial institution, to deposit funds in the account of the second financial institution. On receiving the authorization (e.g., a numeric or alphanumeric string representing an assent to the deposit of funds), the first financial institution may debit the account of the customer and credit the account of the second financial institution. The authorization may cause a financial institution to follow one or more authorization rules with regards to depositing funds in the beneficiary's account. For example, the authorization rules may include requiring that the beneficiary's information be received in a particular format, may determine the maximum amount to be credited in the beneficiary's account, etc.

In one embodiment of the invention, the first financial institution may not request an authorization from the second financial institution prior to debiting the account of its customer and crediting the account of the second financial institution. In one embodiment of the invention, each customer in the master customer list may have associated with the customer's name or identity one or more beneficiary authorization rules. As stated above, the beneficiary authorization rules may include e.g., requiring that the beneficiary's information is in a particular format, the maximum amount of funds to be credited to the beneficiary's account, etc. Each financial institution checks the beneficiary authorization rules corresponding to the beneficiary, complies with the beneficiary authorization rules, then debits its customers account and credits the account of the second financial institution. Thus, the need to obtain authorization from a financial institution prior to transferring funds is eliminated. In one embodiment of the invention, the beneficiary authorization rules are sent by a financial institution to another financial institution as part of the customer list as described with respect to 305 above. At 340, the first financial institution and the second financial institution periodically settle net payments owed to each other. For example, if at the end of a day the first financial institution owes the second financial institution a net amount as a result of various transactions between the financial institutions, the first financial institution credits the account of the second financial institution with the net amount owed.

If at 325, the first financial institution determines that the beneficiary is not on the master customer list, at 335 the first financial institution sends the funds to the beneficiary via default means. Default means comprises means as described with respect to FIG. 2.

In one embodiment of the invention, the financial institutions transfer funds (by following the method illustrated in FIG. 3) in real time i.e., as soon as instructed to do so by its customers. In one embodiment of the invention, the financial institutions transfer the funds in batch mode i.e., once a sufficient volume of transactions have accumulated, or at a certain configurable time of day. Each financial institution may settle the net debt owed to the other financial institution via a periodic transfer of funds.

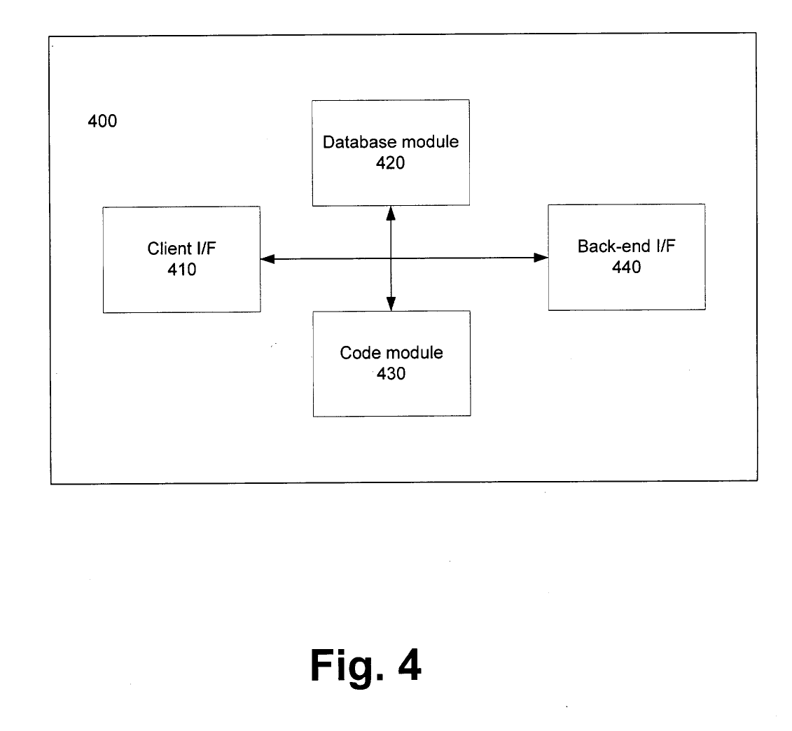

FIG. 4 illustrates a funds transfer module according to one embodiment of the invention. As Illustrated in FIG. 4, the funds transfer module 400 comprises a client interface 410, a Database module 420, a code module 430, and a back-end interface 440 coupled to each other as shown. The client interface 410 interfaces with a client e.g., a customer of a financial institution. In particular, client interface 410 may interface with a customer's computer, PDA, wireless device, etc. Client interface 410 may also interface with the funds transfer module of another financial institution or with an ASP. Client interface 410 may thus transmit and receive transaction information, customer lists, the list of participating financial institutions, send authorization requests, and receive acknowledgements, authorizations, etc.

Database module 420 coupled to code module 430, client interface 410 and to back-end interface 440 comprises one or more databases e.g., relational databases to store customer lists, the list of participating financial institutions, customer information, beneficiary authorization rules, payment authorizations, transaction information, etc.

Code module 430 comprises the program code to execute the funds transfer methods illustrated with respect to FIGS. 2 and 3. For example, code module 430 may generate the list of participating financial institutions, receive transaction information for a customer and send a request to transfer funds to a beneficiary's financial institution as illustrated with respect to FIG. 2. With respect to the method illustrated in FIG. 3, code module 430 may receive transaction information, send a request to a beneficiary's financial institution, retrieve a first financial institution's customer list from database module 420 and send the retrieved information to client interface 410. Code module 430 may receive, e.g., a customer list from a different financial institution via client interface 410, or via back-end interface 440 and may store the information in database module 420. Code module 430 may store the transaction information received from a customer of the financial institution, via client interface 410, in database module 420. Code module 430 may search database module 420 to determine whether a customer is a customer of the first financial institution and if so, credit the customer's account and debits the beneficiary financial institution's account. If code module 430 determines that a customer is a customer of the second financial institution, the code module may request an authorization from the second financial institution as described above with respect to FIG. 3. In addition, code module 430 may execute one or more beneficiary authorization rules, as described above, prior to crediting the account of the second financial institution and debiting the account of the customer. In one embodiment of the invention, code module 430 may send transaction information along with an authorization to a clearing house if the customer is not on the customer lists stored in database module 420.

Back-end interface 440 coupled to database module 420, code module 430, and client interface 410 may send and/or receive beneficiary and/or customer information from a financial institutions remote server. In one embodiment of the invention, back-end interface 440 may receive marketing information tailored to the particular customer and send the information to client interface 410 for displaying on the customer's screen. The marketing information may be displayed e.g., when the customer logs on to the financial institution's web site to provide the transaction information. In one embodiment of the invention marketing information may include e.g., products and services offered by the financial institution.

In one embodiment of the invention, the financial institutions may implement the methods for transferring funds illustrated in FIGS. 2, and 3 using a Secure Sockets Layer (SSL), or the Transport Layer Security (TLS) protocol (please see Internet Request for Comments (RFC) 3207 for more details). In one embodiment of the invention, the method for transferring funds illustrated in FIGS. 2, and 3 are implemented using Simple Object Access Protocol (SOAP), eXtensible Markup Language (XML), and International Financial eXchange (IFX).

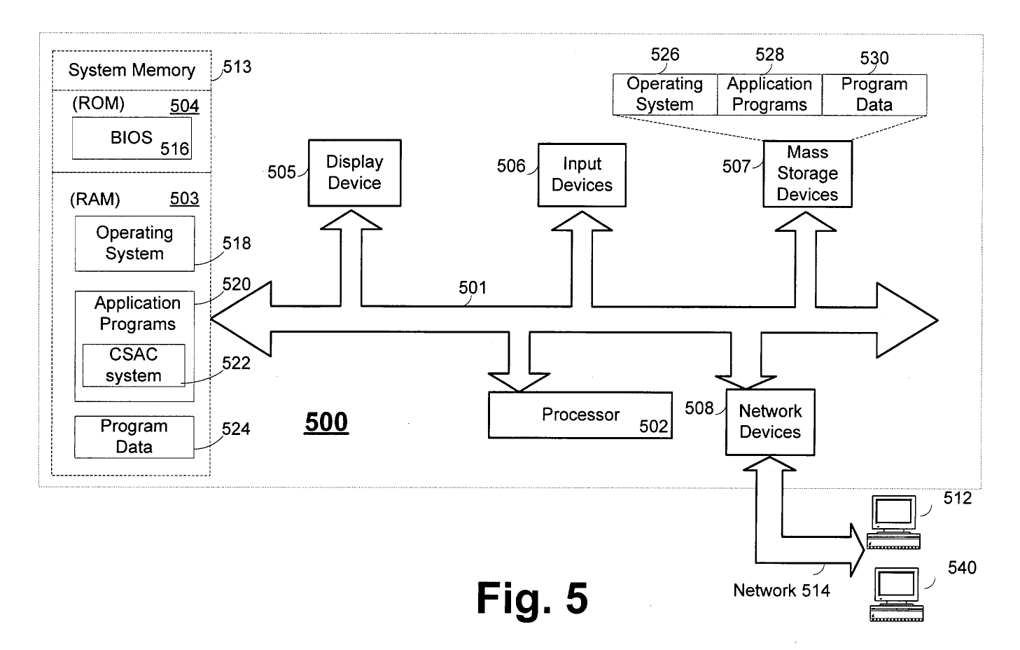

FIG. 5 illustrates an apparatus for transferring funds online according to one embodiment of the invention. The apparatus may comprise a computer system that includes a processor 502 coupled through a bus 501 to system memory 513 and a mass storage device 507.

System memory 513 comprises a read only memory (ROM) 504 and random access memory (RAM) 503. ROM 504 comprises basic input output system (BIOS) 516. RAM 503 comprises operating system 518, application programs 520, and program data 524. Application programs 520 include the program code (e.g., the code module 430 of FIG. 4) for implementing the methods described with reference to FIGS. 2 and 3. Program data 524 may include e.g., customer log-on data, and the master customer list. Mass storage device 507 represents a persistent data storage device, such as a floppy disk drive, fixed disk drive (e.g., magnetic, optical, magneto-optical, or the like), or streaming tape drive. Mass storage device 507 may store application programs 528 including, e.g., the program code to implement the funds transfer method illustrated with respect to FIGS. 2 and 3. Mass storage device 507 may also store the operating system 526 for computer system 500, and program data 530. Processor 502 may be any of a wide variety of general purpose processors or microprocessors (such as the Pentium® processor family manufactured by Intel® Corporation), a special purpose processor, or a specifically programmed logic device.

Processor 502 is operable to receive instructions which, when executed by the processor cause the processor execute the funds transfer method illustrated in FIGS. 2 and 3.

Display device 505 is coupled to processor 502 through bus 501 and provides graphical output for computer system 500. Input devices 506 such as a keyboard or mouse are coupled to bus 501 for communicating information and command selections to processor 502. Also coupled to processor 502 through bus 501 is an input/output interface (not shown) which can be used to control and transfer data to electronic devices (printers, other computers, etc.) connected to computer system 500. Computer system 500 includes network devices 508 for connecting computer system 500 to one or more networks 514. Network 514 may be communicatively coupled to an application service provider (ASP) 512, and to a host 540 e.g., a different financial institution. Network devices 508, may include Ethernet devices including network adapters, phone jacks and satellite links. It will be apparent to one of ordinary skill in the art that other network devices may also be utilized.

One embodiment of the invention may be stored entirely as a software product on mass storage 507. Another embodiment of the invention may be embedded in a hardware product, for example, in a printed circuit board, in a special purpose processor, or in a specifically programmed logic device communicatively coupled to bus 501. Thus, the program code may include instructions for transferring funds online as illustrated with respect to FIGS. 2, and 3.

Thus, a method and apparatus have been disclosed for transferring funds online. While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method for transferring funds online, from a customer's account at a first financial institution to a beneficiary's financial institution comprising:
receiving transaction information comprising a beneficiary's identity, an amount to transfer to a beneficiary's account, and the beneficiary's financial institution's identity;
sending a request to the beneficiary's financial institution, said request comprising the beneficiary's identity and the amount to transfer to the beneficiary's account; and
debiting the customer's account at least the amount to transfer to the beneficiary's account if the beneficiary is a customer of the beneficiary's financial institution.

2. The method of claim 1 further comprising receiving an acknowledgement from the beneficiary's financial institution if the beneficiary is a customer of the beneficiary's financial institution.

3. The method of claim 1 further comprising at least one of sending the beneficiary's financial institution a net payment and receiving from the beneficiary's financial institution a net payment.

4. The method of claim 1 further comprising debiting the customer's account if the beneficiary is not a customer of the beneficiary's financial institution and any one of, sending a check to the beneficiary, and sending at least the amount to transfer to the beneficiary to a clearing house.

5. The method of claim 1 wherein the beneficiary's identity comprises at least one of the beneficiary's name, the beneficiary's email address, and the beneficiary's account number.

6. The method of claim 1 further comprising displaying marketing information when receiving transaction information.

7. A method for transferring funds online, from a customer's account at a first financial institution to a beneficiary's financial institution comprising:
receiving a request from the first financial institution, said request comprising a beneficiary's identity and the amount to transfer to the beneficiary's account;
determining whether the beneficiary is a customer of the beneficiary's financial institution;
sending an acknowledgement if the beneficiary is a customer of the beneficiary's financial institution; and
crediting the beneficiary's account the amount to transfer to the beneficiary if the beneficiary is a customer of the beneficiary's financial institution.

8. The method of claim 7 further comprising at least one of, sending the first financial institution a net payment and receiving from the first financial institution a net payment.

9. The method of claim 7 wherein determining whether the beneficiary is a customer of the beneficiary's financial institution comprises searching a customer list to determine if the beneficiary is a customer of the beneficiary's financial institution.

10. An apparatus to transfer funds online, from a customer's account at a first financial institution to a beneficiary's financial institution, comprising:
a network device to receive transaction information comprising a beneficiary's identity, an amount to transfer to the beneficiary's account, and the beneficiary's financial institution's identity;
a processor coupled to the network device to execute a program said program to send a request to the beneficiary's financial institution via the network device, said request comprising the beneficiary's identity and the amount to transfer to the beneficiary's account, and said program to debit the customer's account at least the amount to transfer to the beneficiary's account if the beneficiary is a customer of the beneficiary's financial institution.

11. The apparatus of claim 10 further comprising the network device to receive an acknowledgement from the beneficiary's financial institution if the beneficiary is a customer of the beneficiary's financial institution.

12. The apparatus of claim 10 wherein the program to send the request to the beneficiary's financial institution said request comprising the beneficiary's identity comprises the program to send at least one of the beneficiary's name, the beneficiary's email address, and the beneficiary's account number to the beneficiary's financial institution.

13. An article of manufacture comprising:
a machine-accessible medium including instructions that, when executed by a machine, causes the machine to perform operations comprising:
receiving transaction information comprising a beneficiary's identity, an amount to transfer to the beneficiary's account, and the beneficiary's financial institution's identity;
sending a request to the beneficiary's financial institution, said request comprising the beneficiary's identity and the amount to transfer to the beneficiary's account; and
debiting the customer's account at least the amount to transfer to the beneficiary's account if the beneficiary is a customer of the beneficiary's financial institution.

14. The article of manufacture of claim 13 comprising further instructions for receiving an acknowledgement from the beneficiary's financial institution if the beneficiary is a customer of the beneficiary's financial institution.

15. An article of manufacture comprising:
a machine-accessible medium including instructions that, when executed by a machine, causes the machine to perform operations comprising:
receiving a request from a first financial institution, said request comprising the beneficiary's identity and the amount to transfer to the beneficiary's account;
determining whether the beneficiary is a customer of the beneficiary's financial institution;
sending an acknowledgement if the beneficiary is a customer of the beneficiary's financial institution; and
crediting the beneficiary's account the amount to transfer to the beneficiary if the beneficiary is a customer of the beneficiary's financial institution.

16. The article of manufacture of claim 15 further comprising instructions for at least one of, sending the first financial institution a net payment and receiving from the first financial institution a net payment.

17. The article of manufacture of claim 15 wherein said instructions for determining whether the beneficiary is a customer of the beneficiary's financial institution comprises further instructions for searching a customer list to determine if the beneficiary is a customer of the beneficiary's financial institution.

18. A method for transferring funds online, between a first financial institution and a beneficiary's financial institution, comprising:
sending a first customer list of the first financial institution to the beneficiary's financial institution;
receiving a second customer list from the beneficiary's financial institution;
receiving transaction information comprising a beneficiary's identity, an amount to transfer to the beneficiary's account, and the beneficiary's financial institution's identity;
searching the first and the second customer lists to determine if the beneficiary's identity is on at least one of the first customer list and the second customer list; and
debiting the customer's account at least the amount to transfer to the beneficiary's account if the beneficiary's identity is on at least one of the first customer list and the second customer list.

19. The method of claim 18 wherein debiting the customer's account at least the amount to transfer to the beneficiary if the beneficiary's identity is on at least one of the first customer list and the second customer list comprises:
sending an authorization request to the beneficiary's financial institution;
debiting the customer's account at least the amount to transfer to the beneficiary's account; and
sending the amount to transfer to the beneficiary's account, to the beneficiary's financial institution.

20. The method of claim 18 further comprising at least one of sending the beneficiary's financial institution a net payment and receiving from the beneficiary's financial institution a net payment.

21. The method of claim 18 wherein receiving a second customer list from the beneficiary's financial institution comprises receiving a master customer list said master customer list comprising customers of the first financial institution and customers of the second financial institution.

22. The method of claim 18 further comprising debiting the customer's account if the beneficiary's identity is not on at least one of the first customer list and the second customer list, and
any one of, sending a check to the beneficiary, and sending at least the amount to transfer to the beneficiary's account to a clearing house.

23. The method of claim 18 wherein the beneficiary's identity comprises at least one of the beneficiary's name, the beneficiary's email address, and the beneficiary's account number.

24. The method of claim 18 further comprising displaying marketing information when receiving transaction information.

25. A method for transferring funds online, between a first financial institution and a beneficiary's financial institution, comprising:
receiving a first customer list including customer names of the first financial institution;
sending a second customer list including customer names of the beneficiary's financial institution to the first financial institution;
receiving an amount to deposit in the beneficiary's account from the first financial institution; and
crediting the beneficiary's account with the amount to deposit in the beneficiary's account.

26. The method of claim 25 further comprising at least one of, sending the first financial institution a net payment and receiving from the first financial institution a net payment.

27. The method of claim 25 wherein receiving a first customer list including customer names of the first financial institution comprises receiving a master customer list said master customer list comprising the first customer list and the second customer list.

28. An apparatus to transfer funds online, between a first financial institution and a beneficiary's financial institution, comprising:
a network device to send a first customer list of the first financial institution to the beneficiary's financial institution, to receive a second customer list from the beneficiary's financial institution, and to receive transaction information, said transaction information comprising a beneficiary's identity, an amount to transfer to the beneficiary's account, and the beneficiary's financial institution's identity
a processor coupled to the network device to search the first and the second customer list to determine if the beneficiary's identity is on at least one of the first customer list and the second customer list, and said processor to debit the customer's account at least an amount the amount to transfer to the beneficiary's account if the beneficiary's identity is on at least one of the first customer list and the second customer list.

29. The apparatus of claim 28 wherein the processor to debit the customer's account at least an amount the amount to transfer to the beneficiary's account if the beneficiary's identity is on at least one of the first customer list and the second customer list comprises the processor to send an authorization request to the beneficiary's financial institution, the processor to debit the customer's account at least the amount to transfer to the beneficiary's account, and the processor to send the amount to transfer to the beneficiary's account to the beneficiary's financial institution.

30. The apparatus of claim 28 wherein network device to receive a second customer list from the beneficiary's financial institution comprises the network device to receive a master customer list said master customer list comprising customer identities of the first financial institution and customer identities of the second financial institution.

31. An article of manufacture comprising:
a machine-accessible medium including instructions that, when executed by a machine, causes the machine to perform operations comprising
sending a first customer list of the first financial institution to the beneficiary's financial institution;
receiving a second customer list from the beneficiary's financial institution;
receiving transaction information comprising a beneficiary's identity, an amount to transfer to the beneficiary's account, and the beneficiary's financial institution's identity;
searching the first and the second customer lists to determine if the beneficiary's identity is on at least one of the first customer list and the second customer list; and
debiting the customer's account at least the amount to transfer to the beneficiary's account if the beneficiary's identity is on at least one of the first customer list and the second customer list.

32. An article of manufacture as in claim 31, wherein said instructions for debiting the customer's account at least the amount to transfer to the beneficiary if the beneficiary's identity is on at least one of the first customer list and the second customer list comprises further instructions for
sending an authorization request to the beneficiary's financial institution;
debiting the customer's account at least the amount to transfer to the beneficiary's account; and
sending the amount to transfer to the beneficiary's account to the beneficiary's financial institution.

33. An article of manufacture as in claim 31, comprising further instructions for at least one of sending the beneficiary's financial institution a net payment and receiving from the beneficiary's financial institution a net payment.

34. An article of manufacture as in claim 31, wherein said instructions for receiving a second customer list from the beneficiary's financial institution comprises further instructions for receiving a master customer list said master customer list comprising customers of the first financial institution and customers of the second financial institution.

35. An article of manufacture as in claim 31 further comprising further instructions for
debiting the customer's account if the beneficiary's identity is not on at least one of the first customer list and the second customer list, and
any one of, sending a check to the beneficiary, and sending at least the amount to transfer to the beneficiary's account to a clearing house.
